(19) United States
(12) Patent Application Publication
(10) Pub. No.: US 2003/0110110 A1
(43) Pub. Date: Jun. 12, 2003

(54) Operation of bank-note processing systems

(76) Inventors: Jurgen Dietz, Munchen (DE); Graham Rawlings, Puchheim (DE); Thomas Hildebrandt, Kirchheim (DE); Klaus Buchmann, Munchen (DE); Norbert Holl, Germering (DE)

Correspondence Address: BACON & THOMAS, PLLC, 625 SLATERS LANE, FOURTH FLOOR, ALEXANDRIA, VA, 22314

(21) Appl. No.: 10/288,457

(22) Filed: Nov. 6, 2002

(30) Foreign Application Priority Data
Nov. 6, 2001 (DE) 101 54 342.5

(51) Int. Cl. G06F 17/60

(52) U.S. Cl. 705/35

(57) ABSTRACT

A bank-note processing system comprises bank-note processing machines (M1-M4) set up in a room (R) and adapted to be individually operated wirelessly by a control unit (BE). In dependence on the position of the control unit (BE) within the room (R) the control unit is configured by the closest machine (e.g. M4), for which purpose said machine (M4) passes machine-typical data to the control unit (BE) in a log-in procedure. The control unit (BE) can be used to wirelessly operate different bank-note processing machines even of different types. This simplifies operation, on the one hand, and permits simpler realization of security measures, on the other hand, e.g. the limitation of operation to certain operating functions for certain groups of persons within one and the same room.

This invention relates to a bank-note processing system having at least one bank-note processing machine located in a room, for example an automatic teller, bank-note sorter or the like, and a control unit for operating said bank-note processing machine by wireless communication between the control unit and the bank-note processing machine.

The operation of bank-note processing systems comprising one or more processing machines distributed in a room, for example automatic tellers, bank-note sorters or the like, must meet special requirements since the material to be processed (bank notes) requires special security measures and furthermore the group of persons allowed to operate such machines is limited.

One problem in operating such processing machines is the control unit, which is usually structurally connected with and integrated in the processing machines, since this requires considerable effort.

For bank-note processing machines, DE 199 58 017 A1 therefore shows a wireless connection between a bank-note sorter and a control unit equipped with a display and adapted to be coupled wirelessly with the machine.

With reference thereto, this invention is based on the problem of providing a bank-note processing system that permits versatile use of a control unit.

This problem is solved by a bank-note processing system according to claim 1. Preferred embodiments are the subject matter of the subclaims.

The inventive bank-note processing system will thus preferably have the following two special features: firstly, automatic position determination is effected for the control unit within the room or rooms where the bank-note processing machines are set up and, secondly, an (automatic) configuration of the control unit is effected for a specific bank-note processing machine in dependence on the ascertained position of the control unit within the room or rooms.

Communication between the control unit and the bank-note processing machine is effected wirelessly, for example and preferably with the aid of the bluetooth norm, which is an international convention for close-range communication that permits communication free of charge due to the limitation to short distances.

Operation refers in particular to a control action on the machine. However, operation can alternatively refer to a check, e.g. a display of functions of the machine not necessarily also triggering any certain machine functions for control.

The control unit can preferably be formed as a Web pad. Alternatively, it is also possible to use so-called data or cyber-goggles, which display additional information to the wearer when he views a device. This can be used to see a display of trouble spots in the machine so that personnel can quickly eliminate the trouble.

The way of configuring the control unit preferably depends on which bank-note processing machine is located closest to the control unit at the moment. After configuration of the control unit for a certain machine, the control unit can be coupled with a mounting located on the machine so that the control unit can be charged for example inductively via the mounting during operation of the machine.

If a Web pad is used, operation can usually be effected by hand, but it will preferably be effected by speech input both with the Web pad and with cyber-goggles, so that the operator has both hands free for other activities. The inputted speech commands are processed into control signals and operating signals that are transferred to the bank-note processing machine.

The inventive processing system with the wireless, self-configuring control unit is especially advantageous when a plurality of processing machines for bank notes, which can be of the same type or different types, are set up in the room. Ascertaining the position of the control unit within the room permits unique allocation of the control unit to a processing machine. If a plurality of processing machines are located at roughly same distance from the control unit, said plurality of machines can be shown on a display so that the operator can make a selection. Alternatively, it is also possible for the plurality of processing machines to be located in different rooms.

When a control unit (carried by a person) approaches a certain bank-note processing machine, this state is automatically recognized, and configuring of the control unit is effected in accordance with the peculiarities of the nearby bank-note processing machine. One might consider immediately initiating the configuring process and enabling operation. However, it is especially preferred to provide a log-in procedure by which the operator inputs for example his name, a PIN, a fingerprint or the like into the control unit to prove his authorization. This authorization specially geared to the operator can also be effected beforehand with a personalization station. The operator then inputs the aforementioned data via the control unit, and the control unit sends information to the personalization station. Said personalization station equipped with a computer then passes wirelessly to the control unit an operating profile containing data about the scope of possible control and operating actions the relevant operator is allowed to perform. Such a “profile” can also be created by the relevant bank-note processing machine itself and transferred wirelessly to the control unit; the personalization station can also be integrated into the control unit. Thus, a further separate idea of the present invention is to configure the control units in dependence on the person or group of persons who can use the control units.

After a control connection is made between the control unit and a bank-note processing machine, the processing machine is in a control or adjusting mode different from the normal operating mode. If the control unit is separated locally from the processing machine in this state, its operating state is possibly unstable, that is, operating states can occur that are unpredictable and no longer meet security requirements. In order to avoid this, the invention provides that the bank-note processing machine is blocked as soon as the control unit is recognized to have moved a predetermined distance away from the machine. This state is preferably also signaled by an acoustic and/or optical alarm signal. It is also conceivable that a plurality of operators each equipped with a control unit are located in a room. For example, one operator can approach a machine that is already being operated by another person with an accordingly configured control unit. To avoid an undesirable collision state, the configuring of the new control unit arriving in the area of the machine can then be blocked. It is also pos-blocked. It is also possible to transfer the operating power from one control unit to another. This is preferably effected via a suitable log-in/log-off procedure.

The configuration of a control unit is dependent on the peculiarities of the bank-note processing machine to be operated and also on the scope of operating possibilities available to the person carrying the control unit. For example, the opening of certain machine parts for error handling and/or maintenance can be limited to a certain group of persons since said machine parts are especially security-relevant. These tasks cannot be executed via the control unit if the relevant operator is not authorized.

To obtain unique user identification, the particular operator must input personal data into the control unit, in particular his name, a PIN, a fingerprint or the like. As a further general security measure, the time period for possible operation by the control unit can also be limited.

As mentioned above, a special feature of the invention is that the position of the control unit within the room is determined for performing configuration of the control unit in dependence on the position of the control unit. “Determining the position” of the control unit is to be understood both “relatively” and “absolutely.” Relative position determination means for example that a control unit has a distance from a certain bank-note processing machine that is below a certain minimum distance. This can be determined for example by a field strength measurement, for which purpose the received field strength of a signal sent by the machine is tested in the control unit or the received field strength of a signal sent by the control unit in the machine, for example.

The “absolute position” of the control unit in the room can be determined e.g. with the aid of optical, infrared or other sensors or by a radio or GPS system. A central control computer of the bank-note processing system can process the signals coming from such sensors and determine from said signals the coordinates of the position of the control unit or the operator within the room. Since the positions of the individual bank-note processing machines are likewise known, the machine closest to the relevant control unit can be easily determined.

Means provided for determining the position of a control unit are in particular:

a transmitter located on the control unit whose signals are received by sensors in the room and supplied to an evaluation device; and/or

a receiver located on the control unit for receiving signals from at least one transmitter located in the room and supplying them to an evaluation device, or

a transceiver located on the control unit for communicating with at least one transceiver and/or transmitter and/or receiver in the room.

The abovementioned possibilities can be used to determine alternatively the absolute position of the control unit with respect to the room and thus to the individual processing machines in the room, or the position of the control unit relative to a processing machine.

The signals for operating/controlling the individual bank-note processing machines are transferred wirelessly by the control unit to the processing machine, the same applying to feedback from the machine to the control unit. For clean separation of the individual signals, the channels for transferring such control/operating signals are therefore separate from channels for transferring signals for determining the position of the control unit. However, it is alternatively also possible for control/operating signals and position signals to be transferred in combination over common channels.

In the following, some examples of the invention will be explained in more detail with reference to the drawing, in which:

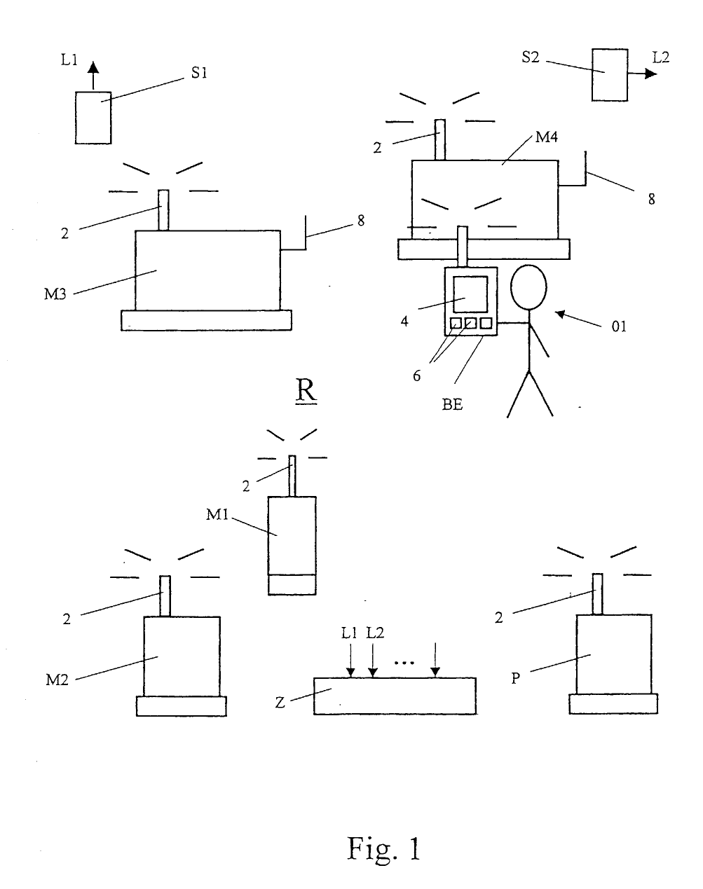

FIG. 1 shows a schematic block diagram of a bank-note processing system installed in a room, having a plurality of bank-note processing machines, position sensors and a personalization station as well as a central computer;

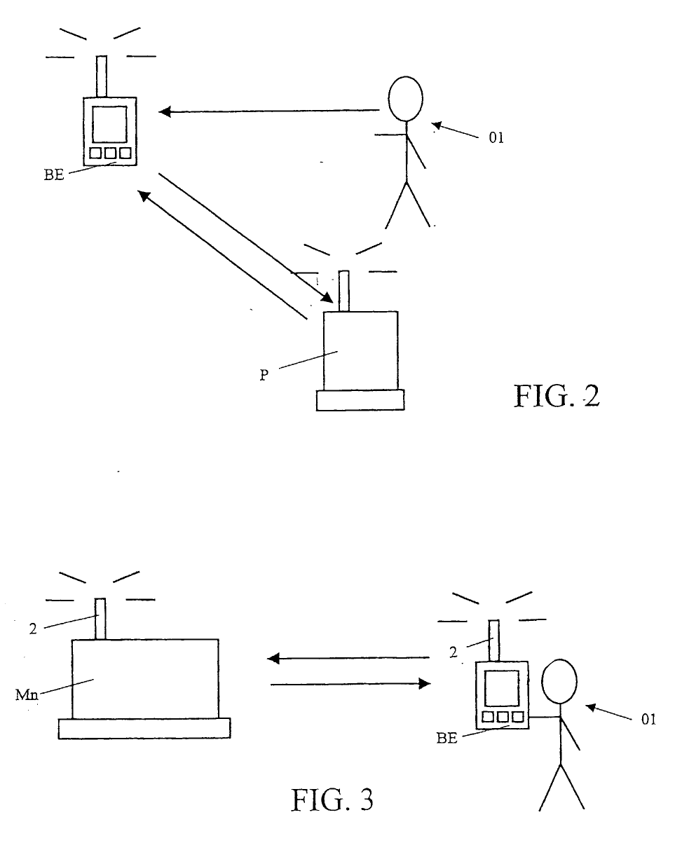

FIG. 2 shows a schematic block diagram for explaining a personalization procedure or hand-over procedure between a control unit carried by an operator and a personalization station;

FIG. 3 shows a schematic block diagram for explaining a configuring procedure between a bank-note processing machine and a control unit;

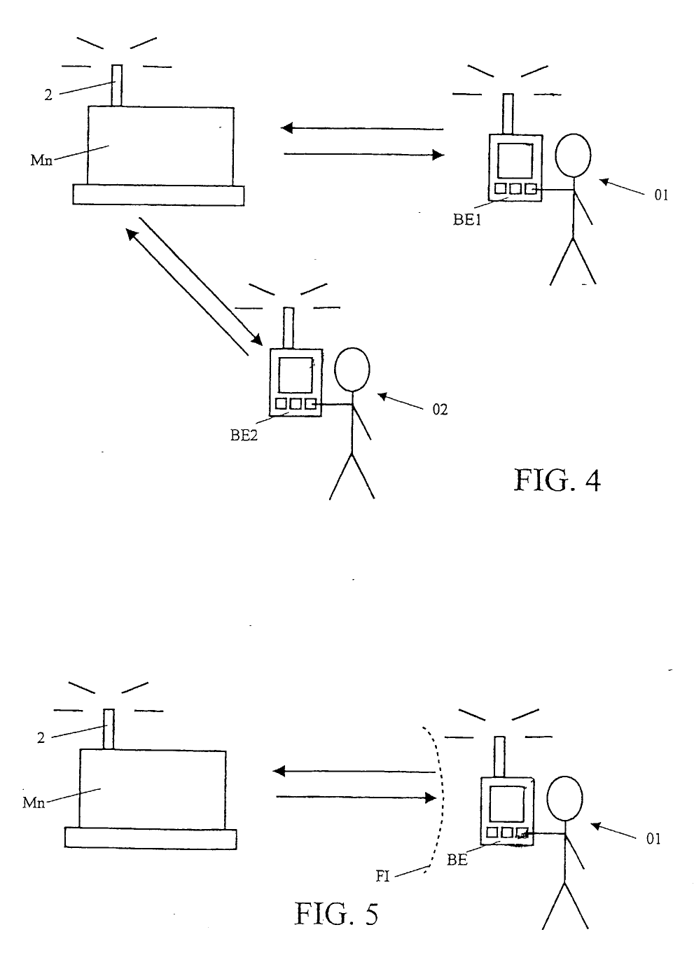

FIG. 4 shows a schematic block diagram for illustrating a sequence in which the operation of a bank-note processing machine is taken over by one control unit from another control unit; and

FIG. 5 shows a schematic block diagram of a log-off procedure.

In the following, some examples of an inventive bank-note processing system will be described.

FIG. 1 shows a block diagram of room R in which a bank-note processing system is installed. Said system comprises a plurality of bank-note processing machines M1-M4, here in the form of strongbox M1, processing place M2, first bank-note sorter M3 and second bank-note sorter M4. Central station Z with a computer is located in or outside room R. Individual bank-note processing machines M1 to M4, abbreviated as BBMs in the following, each have transceiving antenna 2 for radio contact with control unit BE likewise equipped with transceiving antenna 2 and held by operator O1.

Personalization station P likewise with transceiving antenna 2 is also located in room R. At fixed places in the room there are furthermore two sensors S1 and S2 formed in the way known in the art for detecting a person moving in the room (and thus control unit BE carried by person O1).

BBMs M1 to M4 each contain a transceiver for transmitting and receiving signals via transceiving antenna 2. The BBMs have integrated therein sensors and actuating devices for detecting operating states of the particular machine and sending them by means of corresponding signals or for receiving the actuating signals from control unit BE via transceiving antenna 2 and performing corresponding adjusting processes.

Control unit BE is preferably a so-called Web pad whose design is known in the art and need not be explained in any detail here. Control unit BE generally contains display 4 and control keyboard 6 so that person O1 can read information from control unit BE and input information into control unit BE via keyboard 6, for example alpha-numeric entries, a fingerprint (via a sensor not shown in detail here). Furthermore, a speech input apparatus of control unit BE (not shown in detail here) can be provided so that acoustic operating commands can also be inputted.

It should already be noted at this point that the control unit can also be formed differently, being designed for example as so-called cyber-goggles that permit information input and output in connection with a speech recognition system.

All BBMs can be connected with central computer Z by radio or by wires.

The further structural peculiarities of the bank-note processing system will become clear in connection with the following description of the mode of working thereof. Let us assume that person O1 enters room R.

According to FIG. 2, the following procedure is then effected for personalizing control unit BE:

1. Person O1 inputs his name, a PIN and a fingerprint via control unit BE.

2. The control unit signals in response wirelessly (radio, infrared or the like) the name and PIN, optionally also fingerprint data (FaD) of person O1 to personalization station P. Personalization station P performs an authentication procedure and delivers a signal to BE.

3. The signal sent wirelessly by personalization station P to control unit BE contains a profile comprising a time period and the scope of operating possibilities for person O1.

Person O1 then goes within room R to one of the BBMs located there to operate it, for example adjust it, adapt it, switch it on or off.

According to FIG. 3, person O1 with control unit BE approaches one of the BBMs, designated Mn here by way of example. In a first embodiment, the approach of control unit BE is recognized by the BBM itself. In a second embodiment, said ap-approach is recognized with the aid of sensors S1 and S2 shown in FIG. 1 and center Z connected therewith by lines L1 and L2. In any case there is a unique allocation between BBM Mn according to FIG. 3 and control unit BE. Person O1 then signals his name “A” wirelessly to machine Mn, whereupon the machine sends back data about this specific machine to control unit BE. After this first and second data exchange, “Mn” is then indicated as the relevant machine on control unit BE as the third step, person O1 optionally also being asked via the display to log into the machine.

The previous personalization of control unit BE specifies which operating actions can be performed on the relevant BBM by person O1 or by control unit BE carried by person O1.

For logging into a certain BBM, person O1 sends his name “A” wirelessly to machine Mn which thereupon sends a signal back to control unit BE, signifying “Logged in” for example, whereupon a display appears on display device 4 according to which person O1 is offered all permitted operating actions. It may also be, however, that the log-in is rejected, for example because the relevant machine has a disturbance or because control unit BE is not permitted to perform any operating actions on said machine.

After log-in, person O1 can insert control unit BE into mounting 8 of the machine and make entries on the control unit while control unit BE is being charged (e.g. inductively) in mounting 8. On display device 4 of control unit BE, feedback signals from machine Mn can be read off.

FIG. 4 shows the case that machine Mn is being operated by person O2 via control unit BE2 while operator O1 with control unit BE1 approaches machine Mn. In the following the possible sequence of a takeover of operation by person O1 will be described:

1. Person O1 passes his name “A” wirelessly to machine Mn as soon as control unit BE1 is located within the radio network island of machine Mn.

2. Machine Mn sends data concerning machine Mn to control unit BE1.

3. Via display device 4 person O1 is offered the takeover of operation of machine Mn.

4. Machine Mn sends name “A” of person O1 to control unit BE2.

5. Display device 4 of control unit BE2 indicates name “A.”

6. Person O1 inputs the wish “Take over” to control unit BE1.

7. Control unit BE1 sends the inquiry “Take over?” to machine Mn.

8. Thereupon machine Mn sends the inquiry “Hand over to ”A “?” to control unit BE2.

(Alternatively machine Mn can send a signal “Takeover denied” to control unit BE1.)

Person O2 can deny the takeover of operation by person O1 with the name “A”, he can also consent.

9. In the case of consent to the takeover, operator O2 sends a response “Yes” to machine Mn via control unit BE2.

10. Thereupon machine Mn sends a signal “Taken over” to control unit BE1, where-upon

11. all operating actions are enabled on display device 4 of control unit BE1.

It is of course also possible that the two persons O1 and O2 have different authorities, so that person O2 can possibly perform only some of the possible operating actions while person O1 can perform all operating actions. The reverse situation is also possible.

If a person approaches an area where two nearby BBMs respond, display device 4 of the control unit shows a list of the relevant machines, and the person can make a selection among the possible candidates for operation.

At the end of an operating procedure, the person can log off from the BBM just operated.

FIG. 5 schematically shows the log-off procedure:

1. By a corresponding input to control unit BE, person O1 causes control unit BE to

2. send a signal “Log off?” to machine Mn.

3. Machine Mn sends back a signal “Logged off” to control unit BE, and the latter indicates machine “Mn,” as at 3 in FIG. 3, while simultaneously offering a (new) log-in.

As mentioned above, the transceiver in machine Mn has a certain range, thereby defining a “radio network island.” Its limit is indicated as FI in FIG. 5. When person O1 leaves said radio network island over limit FI, machine Mn is in an unstable state, i.e. the machine is set for operation but there is no control unit in the catchment area of the machine. To avoid unstable conditions, machine Mn can be blocked. Display device 4 of control unit BE changes in such a way that relevant machine Mn is no longer shown; an alarm signal can additionally be generated, for example by a flash signal or acoustic signal, so that person O1 knows that he is no longer in the area of the radio network island of the machine. Upon reentry into the area of the radio network island, the previous state in which all actions are permitted can be automatically restored.

A simplified possibility for temporarily stopping operation of a machine is to input a pause signal (block) via the control unit. This pause state can be lifted by reinputting the fingerprint for example. During the pause state the control unit is blocked so that no unauthorized person can operate the relevant machine either via this control unit or via another control unit. (Should an attempt be made to operate the machine via another control unit, control unit BE1 would first have to consent to the takeover of operation.)

When the operator leaves room R, control unit BE is preferably handed over by a corresponding hand-over procedure. This is shown schematically in FIG. 2 by steps X1, X2 and X3:

X1: Person O1 inputs a “Hand over” signal to control unit BE.

X2: Control unit BE passes a “Hand over?” signal in connection with the name of person O1 to personalization station P.

X3: Personalization station P sends back a “Handed over” signal to control unit BE1.

The control unit is thus back in the state it was in when person O1 with control unit BE entered.

In the above-described example, BBMs M1-M4, the personalization station and the control units are each equipped with a transceiver and corresponding transceiving antenna 2. With somewhat reduced performance, individual devices can be equipped with only a transmitter or a receiver.

Thus, a bank-note processing system according to the present invention preferably comprises bank-note processing machines (M1-M4) set up in a room (R) and adapted to be individually operated wirelessly by a control unit (BE). In dependence on the position of the control unit (BE) within the room (R), the control unit is configured by the closest machine (e.g. M4), for which purpose said machine (M4) passes machine-typical data to the control unit (BE) in a log-in procedure. The control unit (BE) can be used for wireless operation of different bank-note processing machines even of different types. This simplifies operation, on the one hand, and permits simpler realization of security measures, on the other hand, e.g. the limitation of operation to certain operating functions for certain groups of persons e.g. also within one and the same room.

1. A bank-note processing system comprising:
at least one bank-note processing machine (M1-M4; Mn);
a control unit (BE; BE1, BE2) communicating wirelessly with the at least one bank-note processing machine for coperation thereof,
characterized in that the control unit (BE; BE1, BE2) has associated therewith a device for determining the position of the control unit, and the bank-note processing system further includes a device for configuring the control unit for a certain bank-note processing machine in dependence on the position of the control unit.

2. A processing system according to claim 1, characterized in that two or more bank-note processing machines (M1-M4) are present that are located in one or more rooms (R).

3. A bank-note processing system according to claim 1 or 2, characterized in that the device determines the position of the control unit within at least one of the rooms (R) in which at least one of the bank-note processing machines (M1-M4; Mn) is located and/or with respect to at least one of the bank-note processing machines (M1-M4; Mn).

4. A processing system according to any of claims 1 to 3, characterized in that the control unit is formed as a Web pad.

5. A processing system according to any of claims 1 to 3, characterized in that the control unit has cyber-goggles (data goggles).

6. A processing system according to claim 4 or 5, characterized in that the control unit has a speech processing device.

7. A processing system according to any of claims 1 to 6, characterized in that the bank-note processing machine is equipped with a mounting (8) for the control unit.

8. A processing system according to claim 7, characterized in that the control unit operated by means of an accumulator is adapted to be coupled with a charging device in the mounting (8).

9. A processing system according to any of claims 1 to 8, characterized in that the device performs the configuration of the control unit in dependence on an operator or group of operators operating the control unit.

10. A processing system according to any of claims 1 to 9, characterized in that the control unit has a display device (4) and an input device (6), the configuration defining the display on the display device and/or the input possibilities with the input device (6).

11. A processing system according to any of claims 1 to 10, characterized in that the configuration of the control unit is effected in accordance with that bank-note processing machine locally closest to the control unit.

12. A processing system according to any of claims 1 to 10, characterized in that if a plurality of candidates for a bank-note processing machine (M1-M4) to be operated are present upon position detection, said candidates are stated by the control unit.

13. A processing system according to any of claims 1 to 12, characterized in that a log-in/log-off procedure is set up between the control unit and each bank-note processing machine to be operated.

14. A processing system according to claim 13, characterized in that the log-in/log-off procedure defines an operating scope that depends on a person handling the control unit.

15. A processing system according to any of claims I to 14, characterized in that the at least one bank-note processing machine is adapted to be blocked if the control unit operating it moves a predetermined distance away from said bank-note processing machine.

16. A processing system according to claim 15, characterized in that an alarm signal is generated if the bank-note processing machine is blocked.

17. A processing system according to any of claims 1 to 16, characterized in that the configuration of the control unit is blocked if the relevant bank-note processing machine is already being operated by another control unit.

18. A processing system according to any of claims 1 to 17, characterized in that the control unit has a user identification device, for example a fingerprint scanner.

19. A processing system according to any of claims 1 to 18, characterized by a personalization station (P) in which the control unit is configured specifically for one user.

20. A processing system according to claim 19, characterized in that configuration includes:
a time period for possible operation by means of the control unit, and/or
the operating scope for one or more bank-note processing machines.

21. A processing system according to any of claims 1 to 20, characterized in that the device for determining the position of the control unit has:
a transmitter located on the control unit whose signals are received by the sensors in the room (R) and supplied to an evaluation device (Z), and/or
a receiver located on the control unit for receiving signals from at least one transmitter located in the room and supplying them to an evaluation device;
a transceiver located on the control unit for communicating with at least one transceiver and/or transmitter and/or receiver in the room (R).

22. A processing system according to claim 21, characterized in that transmitter and/or receiver and/or transceiver are IR, optical or radio equipment.

23. A processing system according to claim 21 or 22, characterized in that the receiver or transceiver responds to the received signal strength.

24. A processing system according to any of claims 21 to 23, characterized in that signal transmission channels used for position determination are different from the signal transmission channels used for operating the bank-note processing machine.
